(19) United States
(12) Patent Application Publication
(10) Pub. No.: US 2025/0368248 A1
(43) Pub. Date: Dec. 4, 2025

(54) STROLLER

(71) Applicant: GRACO CHILDREN'S PRODUCTS INC., Atlanta, GA (US)

(72) Inventors: Hitoshi YABUUCHI, Tokyo (JP); Tomoyuki HONDA, Tokyo (JP); Shozo MATSUSHITA, Tokyo (JP)

(73) Assignee: GRACO CHILDREN'S PRODUCTS INC., Atlanta, GA (US)

(21) Appl. No.: 19/220,008

(22) Filed: May 27, 2025

(30) Foreign Application Priority Data
May 28, 2024 (JP) 2024-086385
May 28, 2024 (JP) 2024-086386
May 28, 2024 (JP) 2024-086387
Jun. 19, 2024 (JP) 2024-098647
Sep. 2, 2024 (JP) 2024-150580
Sep. 2, 2024 (JP) 2024-150581

(51) Int. Cl. B62B 7/06

(52) U.S. Cl. CPC B62B 7/066; B62B 2205/22

(57) ABSTRACT

A stroller includes: a body frame including a wheel; a handle frame; a first lock mechanism configured to switch one movable portion of the body frame between a locked state and an unlocked state; a second lock mechanism configured to switch another movable portion of the body frame between a locked state and an unlocked state; and an operation member provided in the handle frame and configured to selectively actuate one of the first and second lock mechanisms. The operation member is configured to be operated in a first direction and a second direction different from the first direction. The first lock mechanism is switched to a locked state or an unlocked state by operating the operation member in the first direction. The second lock mechanism is switched to a locked state or an unlocked state by operating the operation member in the second direction.

### CROSS-REFERENCE TO RELATED APPLICATIONS

This application claims priority to the following JP Patent Application Nos.: 2024-086387 filed May 28, 2024; 2024-086386 filed May 28, 2024; 2024-086385 filed May 28, 2024; 2024-098647 filed Jun. 19, 2024; 2024-150580 filed Sep. 2, 2024; and 2024-150581 filed Sep. 2, 2024, the entire contents of which are incorporated herein by reference.

### BACKGROUND

The present invention relates to strollers, and more particularly, to a stroller including a lock mechanism for a movable portion of a body frame.

A stroller typically includes movable portions that allow a stroller body to be folded and movable portions that allow a push bar to be switched from a front-facing position (infant/toddler facing forward) to a rear-facing position (infant/toddler facing rearward). It is well known to provide lock mechanisms for such movable portions to allow an operator to unlock a desired lock mechanism by operating a control near the handle while gripping the handle.

Japanese Patent No. 7315517 discloses a stroller including a first lock mechanism and a second lock mechanism. In this stroller, a handle is provided with an unlock device. The unlock device houses a first unlock module and a second unlock module to which the first lock mechanism and the second lock mechanism are respectively connected via a wire.

### CITATION LIST

### Patent Literature

PTL1: Japanese Patent No. 7315517

### SUMMARY

In the stroller disclosed in Japanese Patent No. 7315517, a selection member is provided that is slidable along the central axis of the handle. By moving the selection member to the right or left side, the one of the first unlock module or the second unlock module that corresponds to the position of the selection member is made ready for actuation. When an operation member is pushed in this state, the unlock module made ready for actuation is actuated, and the corresponding lock mechanism is unlocked.

As described above, the unlock module corresponding to the lock mechanism to be unlocked is actuated by moving the selection member to the right or left side and then pushing the operation member. However, there is a possibility that the operator may mistakenly move the selection member to the wrong side and push the operation member, which may lead to an unintended unlocking operation.

The present invention has been made to address such an issue, and its object is to provide a stroller that allows an operator to easily distinguish between different lock mechanisms when locking or unlocking one of them.

In order to achieve this object, a stroller according to one aspect of the present invention includes a body frame, a handle frame, a first lock mechanism, a second lock mechanism, and an operation member. The body frame includes a wheel. The handle frame configured to perform an operation of moving the body frame. The first lock mechanism is configured to switch one movable portion out of a plurality of movable portions of the body frame between a locked state and an unlocked state. The second lock mechanism is configured to switch another movable portion of the body frame between a locked state and an unlocked state. The another movable portion is located at a different position from the one movable portion. The operation member is provided in the handle frame and is configured to selectively actuate one of the first and second lock mechanisms. The operation member is configured to be operated in a first direction and a second direction different from the first direction. The first lock mechanism is switched to a locked state or an unlocked state by operating the operation member in the first direction. The second lock mechanism is switched to a locked state or an unlocked state by operating the operation member in the second direction.

Preferably, the first direction and the second direction intersect each other.

Preferably, the stroller further includes a first actuation member and a second actuation member. The first actuation member is provided in the handle frame and is connected to the first lock mechanism via a first connecting member. The second actuation member is provided in the handle frame and is connected to the second lock mechanism via a second connecting member. The first actuation member is actuated by operating the operation member in the first direction. The second actuation member is actuated by operating the operation member in the second direction.

Preferably, the first actuation member is displaceable between a first pre-actuation position and a first post-actuation position by operating the operation member in the first direction. The second actuation member is displaceable between a second pre-actuation position and a second post-actuation position by operating the operation member in the second direction. The first lock mechanism is switched to the locked state or the unlocked state via the first connecting member as the first actuation member is moved from the first pre-actuation position to the first post-actuation position through operation of the operation member. The second lock mechanism is switched to the locked state or the unlocked state via the second connecting member as the second actuation member is moved from the second pre-actuation position to the second post-actuation position through operation of the operation member.

Preferably, a direction in which the first actuation member is moved from the first pre-actuation position to the first post-actuation position is a rotational direction, and a direction in which the second actuation member is moved from the second pre-actuation position to the second post-actuation position is a linear direction.

In one embodiment, the handle frame includes a casing that houses the first and second actuation members. The casing forms part of the handle frame. The first actuation member is a rotating body that is rotatably supported by the casing via a shaft and that is rotatable in the rotational direction. The second actuation member holds the operation member such that the operation member is slidable in a direction intersecting the linear direction. The first actuation member includes an engaging portion configured to contact the operation member in the second pre-actuation position.

Preferably, the stroller further includes an elastic member configured to bias the second actuation member toward the second pre-actuation position.

In another embodiment, the handle frame includes a guide member extending along a central axis of the handle frame and fixed to the handle frame. The operation member includes a rotation operation portion and a linear operation portion. The rotation operation portion houses the guide member, the first actuation member, and the second actuation member and is configured to actuate the first actuation member. The linear operation portion is configured to actuate the second actuation member. The rotation operation portion is rotatable around a central axis of the guide member. The first actuation member is fixed to the rotation operation portion.

Preferably, the rotation operation portion holds the linear operation portion such that the linear operation portion is slidable in a direction intersecting the linear direction.

Preferably, the second actuation member is disposed between the guide member and the linear operation portion such that the second actuation member is allowed to contact the linear operation portion. The second actuation member is displaced from the second pre-actuation position to the second post-actuation position as the linear operation portion is moved toward the guide member.

Preferably, the stroller further includes a rotation stopper member configured to switch between an engaged state in which rotation of the rotation operation portion is prohibited and a disengaged state in which the rotation of the rotation operation portion is permitted.

A stroller according to another aspect of the present invention includes a body frame, a handle frame, a first lock mechanism, a second lock mechanism, a first actuation member, a second actuation member, and an operation member. The body frame includes a wheel. The handle frame is configured to perform an operation of moving the body frame. The first lock mechanism is configured to switch one movable portion out of a plurality of movable portions of the body frame between a locked state and an unlocked state. The second lock mechanism is configured to switch another movable portion of the body frame between a locked state and an unlocked state. The another movable portion is located at a different position from the one movable portion. The first actuation member is provided in the handle frame and is connected to the first lock mechanism via a first connecting member. The first actuation member is displaceable between a first pre-actuation position and a first post-actuation position along one direction. The second actuation member is provided in the handle frame and is connected to the second lock mechanism via a second connecting member. The second actuation member is displaceable between a second pre-actuation position and a second post-actuation position along another direction different from the one direction. The operation member is provided in the handle frame and is configured to selectively actuate one of the first and second actuation mechanisms. The first lock mechanism is released from the locked state via the first connecting member as the first actuation member is moved from the first pre-actuation position to the first post-actuation position by the operation member. The second lock mechanism is released from the locked state via the second connecting member as the second actuation member is moved from the second pre-actuation position to the second post-actuation position by the operation member.

In the present invention, one of the first and second lock mechanisms can be selectively activated by operating the operation member in different directions, namely the first and second directions. It is therefore easy for an operator to distinguish which lock mechanism to activate.

### BRIEF DESCRIPTION OF THE DRAWINGS

FIG. 1 is a schematic side view illustrating an example of a body frame and a handle frame of a stroller.

FIG. 2(A) is a schematic side view illustrating how a push bar can be moved, and FIG. 2(B) is a schematic side view of a stroller body in a folded state.

FIG. 3 is a schematic side view illustrating an example of a caster lock mechanism.

FIG. 4 is a schematic perspective view of a handle frame according to a first embodiment as viewed from below.

FIG. 5 is an exploded perspective view of the handle frame of the first embodiment.

FIG. 6 is a schematic sectional view of the handle frame of the first embodiment.

FIGS. 7(A) and 7(B) are schematic sectional views illustrating how a first actuation member of the first embodiment is actuated by an operation lever in a first position.

FIGS. 8(A) and 8(B) are schematic sectional views illustrating the relationship between a second actuation member of the first embodiment and an operation lever in the first position.

FIGS. 9(A) and 9(B) are schematic sectional views illustrating how the second actuation member of the first embodiment is actuated by the operation lever in a second position.

FIGS. 10(A) and 10(B) are schematic sectional views illustrating the relationship between the first actuation member of the first embodiment and the operation lever in the second position.

FIG. 11 is a schematic sectional view of a handle frame according to a second embodiment.

FIGS. 12(A) and 12(B) are schematic sectional views illustrating how a first actuation member of the second embodiment is actuated by an operation lever.

FIGS. 13(A) and 13(B) are schematic sectional views illustrating displacement of a second actuation member of the second embodiment from a second pre-actuation position to a second post-actuation position.

FIG. 14(A) is a schematic rear perspective view of a handle frame according to a third embodiment, and FIG. 14(B) is a schematic front perspective view of this handle frame.

FIG. 15 is an exploded perspective view of the handle frame of the third embodiment.

FIG. 16(A) is a schematic sectional view of the handle frame of the third embodiment, and FIG. 16(B) is a schematic sectional view of the handle frame of the third embodiment in which a handle tube and a guide member are not illustrated.

FIGS. 17(A) to 17(C) are perspective views illustrating displacement of a first actuation member of the third embodiment from a first pre-actuation position to a first post-actuation position.

FIG. 18 is a schematic sectional view illustrating a second actuation member of the third embodiment displaced to a second post-actuation position.

FIGS. 19(A) and 19(B) conceptually illustrate the operation of pulling up a second inner wire.

FIG. 20(A) is a schematic front view illustrating the actuation members that are actuated in the same direction and an operation member that is operated in a different direction, and FIG. 20(B) is a schematic side view of these members.

FIGS. 21(A) and 20(B) are schematic front views illustrating how the operation member is operated in one direction and the first actuation member is actuated in one direction.

FIGS. 22(A) and 22(B) are schematic front views illustrating how the operation member is operated in another direction and the second actuation member is actuated in the same direction as the first actuation member.

FIG. 23(A) is a schematic sectional view illustrating an example in which no notch is provided in the operation lever in the first embodiment.

### DETAILED DESCRIPTION

Embodiments of the present invention will be described in detail with reference to the drawings. The same or corresponding portions are denoted by the same signs throughout the drawings, and description thereof will not be repeated.

### Overview of Stroller

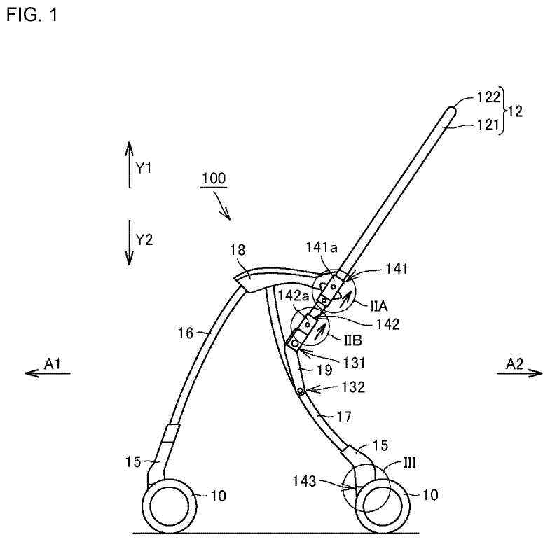

FIG. 1 schematically shows an example of a frame of a stroller 100. The stroller 100 includes a body frame and a handle frame 122. The body frame includes wheels 10, casters 15, front legs 16, rear legs 17, armrests 18, connecting portions 19, side bars 121, push bar lock mechanisms 141, fold lock mechanisms 142, and caster lock mechanisms 143. In FIG. 1, reference signs A1, A2, Y1, and Y2 represent the front, rear, upper, and lower sides, respectively. The same applies to the other figures.

The handle frame 122 is a portion that connects the pair of side bars 121, 121 provided on the right and left sides of the stroller 100. The handle frame 122 is configured to perform an operation of moving the body frame. That is, an operator grips the handle frame 122 to maneuver the stroller 100 forward and backward. The handle frame 122 and the pair of side bars 121 constitute a push bar 12.

### Push Bar Lock Mechanism

The push bar lock mechanism 141 is a well-known structure and is used to switch the push bar 12 between a front-facing position and a rear-facing position. Although a pair of push bar lock mechanisms 141 is provided, one on each of the right and left sides of the stroller 100, only one of them will be described below because they operate in the same manner.

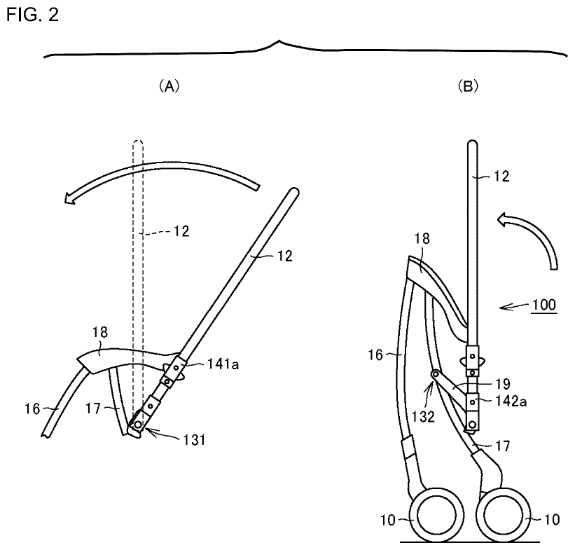

An operation portion (not shown) provided in the handle frame 122 is connected to a handle lock member 141a via a wire (not shown). When the handle lock member 141a is slid upward by operating the operation portion, the handle lock member 141a is unlocked. As shown in FIG. 2(A), the push bar 12 thus becomes pivotable around a push bar pivot base 131. That is, the push bar lock mechanism 141 allows the handle lock member 141a to switchably move between a locked state and an unlocked state.

### Fold Lock Mechanism

The fold lock mechanism 142 is a well-known structure and is used to switch the stroller 100 between an unfolded state and a folded state. Although a pair of fold lock mechanisms 142 is provided, one on each of the right and left sides of the stroller 100, only one of them will be described below because they operate in the same manner.

The operation portion (not shown) provided in the handle frame 122 is connected to an opening and closing lock member 142a via a wire (not shown). When the opening and closing lock member 142a is slid upward by operating the operation portion, the opening and closing lock member 142a is unlocked, and the connecting portion 19 becomes pivotable rearward and pivots around a fold pivot base 132. As a result, as shown in FIG. 2(B), the attitude of the connecting portion 19 is changed and the stroller 100 is folded. That is, the fold lock mechanism 142 allows the opening and closing lock member 142a to switchably move between a locked state and an unlocked state.

### Caster Lock Mechanism

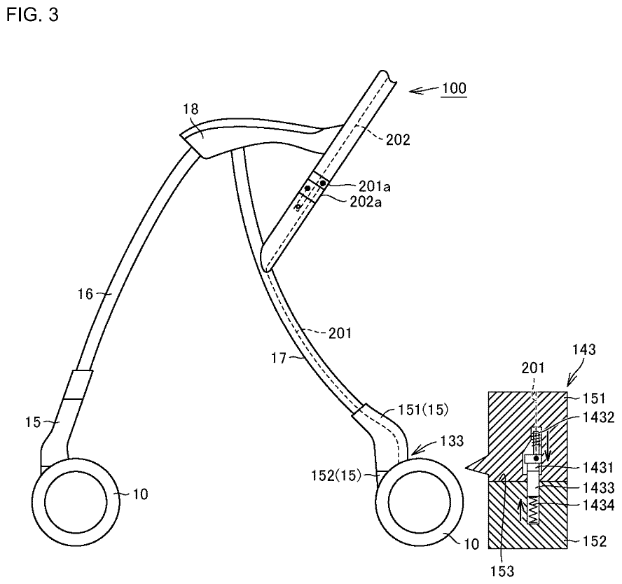

FIG. 3 schematically shows the caster lock mechanism 143. Although a pair of caster lock mechanisms 143 is provided, one on each of the right and left sides of the stroller 100, only one of them will be described below because they operate in the same manner.

The caster lock mechanism 143 includes a push member 1431, a first spring 1432, a lock pin 1433, and a second spring 1434. The push member 1431 is provided in a fixed holder 151. The first spring 1432 biases the push member 1431 downward. The lock pin 1433 is eccentrically provided in a rotatable holder 152. The second spring 1434 biases the lock pin 1433 upward. The push member 1431 is connected to a moving member 201a via a wire 201. The moving member 201a is supported by a drive member 202a from below, and the drive member 202a is connected to the operation portion (not shown) on the handle frame via a wire 202. The drive member 202a is biased upward by a third spring, not shown.

The biasing force of the first spring 1432 is greater than the biasing force of the second spring 1434, but the biasing force of the third spring is greater than the biasing force of the first spring 1432. Therefore, in a locked state, the push member 1431 is pulled upward by the biasing force of the third spring. This allows the lock pin 1433 to protrude upward beyond a boundary portion 153 between the fixed holder 151 and the rotatable holder 152 by the biasing force of the second spring 1434, thereby prohibiting rotation of the rotatable holder 152.

On the other hand, when the wire 202 is pulled by the operation portion to unlock the caster lock mechanism 143, the drive member 202a is pulled downward. This allows the biasing force of the first spring 1432 to act effectively, so that the lock pin 1433 is pushed downward to the boundary portion 153 by the push member 1431. As a result, the rotatable holder 152 becomes rotatable around a rotation axis, not shown, in a caster rotation portion 133. That is, the caster lock mechanism 143 allows the lock pin 1433 to switchably move between a locked state and an unlocked state.

### Movable Portion

As described above, the stroller 100 includes the following three types of movable portions at different positions: the handle lock member 141a that allows the push bar 12 to pivot according to the operation of the push bar lock mechanism 141, the opening and closing lock member 142a that allows the attitude of the connecting portion 19 to be changed according to the operation of the fold lock mechanism 142, and the lock pin 1433 that allows the rotatable holder 152 to rotate according to the operation of the caster lock mechanism 143.

In each embodiment, any two of the three types of movable portions are configured to be moved by locking or unlocking them by remotely operating the corresponding lock mechanisms 141 to 143 from the handle frame 122. These two movable portions will be referred to as “one movable portion” and “another movable portion,” and the corresponding two lock mechanisms will be referred to as “first lock mechanism” and “second lock mechanism.” The structure of each movable portion is merely illustrative, and the movable portions are not limited to the above structures as long as they enable rotation of the push bar, unfolding and folding of the stroller body, and locking and unlocking of the casters.

### First Embodiment

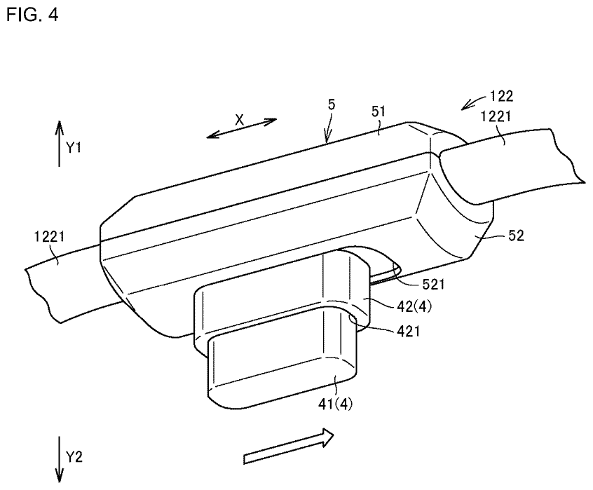

A first embodiment will be described with reference to FIGS. 4 to 10. FIG. 4 schematically shows a casing 5 as viewed from below. The casing 5 forms part of the handle frame 122.

### Overview of Handle Frame

An opening 521 is formed at the bottom of the casing 5, and an operation member 4 extends downward from the opening 521. The operation member 4 is supported by the casing 5 so as to be slidable in the direction in which the handle frame 122 extends (left-right direction). The left-right direction (width direction of the stroller 100) is indicated by reference sign X. The same applies to the other figures.

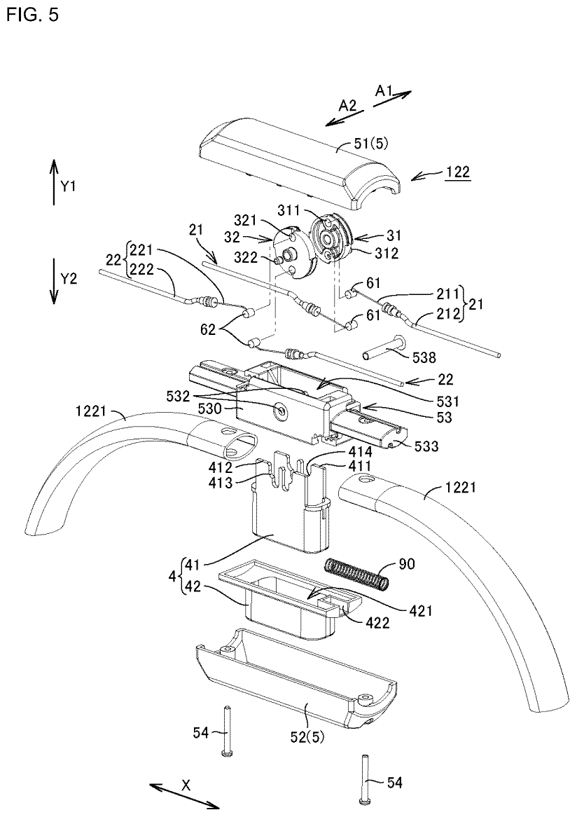

The structure of the handle frame 122 of the present embodiment will be described with reference to FIG. 5. The handle frame 122 includes a pair of handle tubes 1221, a base member 53 attached to the handle tubes 1221, and a cover member (upper cover member 51 and lower cover member 52). The cover member sandwiches the handle tubes 1221 and the base member 53 from above and below and is secured with assembly screws 54. The upper and lower cover members 51, 52 and the base member 53 form the casing 5.

The casing 5 forms part of the handle frame 122 and houses first and second actuation members 31, 32. In the present embodiment, a housing space 531 is formed in the base member 53. The housing space 531 extends through the base member 53 in the up-down direction, and the first actuation member 31 and the second actuation member 32 are housed in the housing space 531. The structure of the base member 53 will be described later.

### Actuation Members

In the present embodiment, the first and second actuation members 31, 32 are both rotating bodies that are rotatably supported by the casing 5 (base member 53) via a rotation shaft 538. The first actuation member 31 has two fixing holes 311 and a first engaging portion (e.g., a pin) 312 at its outer periphery. The second actuation member 32 also has two fixing holes 321 and a second engaging portion (e.g., a pin) 322 at its outer periphery. The first engaging portion 312 and the second engaging portion 322 are positioned offset from each other in the left-right direction. The first and second actuation members 31, 32 are positioned offset from each other in the front-rear direction of the stroller 100. Therefore, connecting members connected to the actuation members 31, 32 do not interfere with each other inside the handle tubes 1221.

### Connecting Members

A pair of first connecting members 21 is connected to the first actuation member 31. Each first connecting member 21 includes a first inner wire 211 and a first outer cover 212 that slidably encloses the first inner wire 211. A first fixture 61 is attached to one end of each first inner wire 211. Each first fixture 61 is fitted into a corresponding one of the fixing holes 311 of the first actuation member 31. In the present embodiment, the first fixtures 61 are fitted into the two fixing holes 311 separated from each other on a straight line, as shown by long dashed double-short dashed lines in the figure.

A pair of second connecting members 22 is connected to the second actuation member 32. Each second connecting members 22 includes a second inner wire 221 and a second outer cover 222 that slidably encloses the second inner wire 221. A second fixture 62 is attached to one end of each second inner wire 221. Each second fixture 62 is fitted into a corresponding one of the fixing holes 321 of the second actuation member 32. In the present embodiment, the second fixtures 62 are fitted into the two fixing holes 321 separated from each other on a straight line, as shown by long dashed double-short dashed lines in the figure.

### Base Member

The base member 53 includes a body 530 and fixing portions 533 provided on the right and left sides of the body 530. Each fixing portion 533 is inserted into a corresponding one of the handle tubes 1221. The body 530 includes the housing space 531 that houses the first and second actuation members 31, 32, and shaft fixing holes 532 through which the rotation shaft 538 passes in the front-rear direction. With the first and second actuation members 31, 32 placed in the housing space 531, the rotation shaft 538 is provided in the body 530 so as to pass through the shaft fixing holes 532 and the first and second actuation members 31, 32. The first and second actuation members 31, 32 are thus rotatably supported via the rotation shaft 538 in the housing space 531, and have a common axis of rotation.

### Operation Member

As will be described later, the operation member 4 of the present embodiment activates one of the first and second lock mechanisms when in one position, and activates the other of the first and second lock mechanisms when in another position. The operation member 4 includes an operation lever 41 and a guide portion 42. The guide portion 42 holds the operation lever 41 such that the operation lever 41 is slidable in the up-down direction. The operation lever 41 includes, on its one upper side (front upper side), a first contact portion 411 and a second notch 414 located adjacent to the first contact portion 411. The first contact portion 411 is configured to contact the first engaging portion 312 of the first actuation member 31.

The operation lever 41 further includes, at the other upper side (rear upper side), a second contact portion 412 and a first notch 413 located adjacent to the second contact portion 412. The second contact portion 412 is configured to contact the second engaging portion 322 of the second actuation member 32. That is, the first contact portion 411 and the second contact portion 412 are formed in the operation lever 41 so as to be offset from each other in the left-right direction. The first notch 413 and the second notch 414 are also formed in the operation lever 41 so as to be offset form each other in the left-right direction.

The guide portion 42 has a guide opening 421 that extends through the guide portion 42 in the up-down direction. The operation lever 41 is inserted through the guide opening 421. As shown in FIG. 4, the lower part of the operation lever 41 is exposed from the guide opening 421 and extends downward. As shown in FIG. 5, a mounting groove 422 for mounting an elastic member 90 is formed on one side of the guide portion 42.

### Assembled State

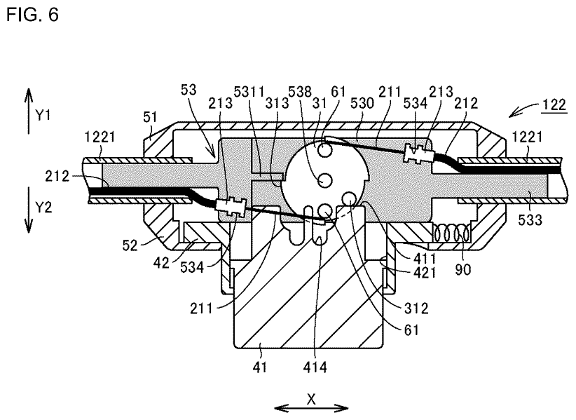

FIG. 6 is a schematic sectional view of the handle frame 122 as viewed from the rear, showing the first connecting members 21 and the first actuation member 31. The second connecting members 22 and the second actuation member 32 are not shown in the figure.

The pair of first connecting members 21 connected to the first actuation member 31 is housed in the body 530 of the base member 53. With the fixing portions 533 of the base member 53 being inserted into the handle tubes 1221, the upper and lower cover members 51, 52 enclose the base member 53 and part of the handle tubes 1221. The base member 53 and the upper and lower cover members 51, 52 are fixed to the handle tubes 1221.

The operation member 4 (guide portion 42) is held by the lower cover member 52 so as to be slidable in the left-right direction. The elastic member 90 (e.g., a spring or rubber) is disposed between the lower cover member 52 and the guide portion 42 and biases the guide portion 42 in one direction. The operation lever 41 is held by the guide portion 42 so as to be slidable in the up-down direction.

That is, the operation member 4 is displaceable between a first position and a second position along a first direction (left-right direction) and is also displaceable from a pre-operation position to a post-operation position along a second direction (up-down direction) intersecting the first direction.

Each first connecting member 21 passes through the inside of a corresponding one of the handle tubes 1221, and an end 213 of the first outer cover 212 is fixed to a mounting groove 534 of the base member 53. The first fixtures 61 each attached to the end of a corresponding one of the inner wires 211 are fitted in the fixing holes 311 of the first actuation member 31.

### Connection Between Actuation Member and Lock Mechanism

The first connecting member 21 having its one end connected to the first actuation member 31 passes through the handle tube 1221 and is connected, at its other end, to one of the handle lock member 141a (FIG. 1), the opening and closing lock member 142a (FIG. 1), or the drive member 202a (FIG. 3). For example, the right and left first connecting members 21 are respectively connected the right and left handle lock members 141a. That is, the first actuation member 31 is connected, via the first connecting member 21, to one (the first lock mechanism) of the three types of lock mechanisms 141 to 143.

The second connecting member 22 having its one end connected to the second actuation member 32 passes through the handle tube 1221 and is connected, at its other end, to any one of the handle lock member 141a (FIG. 1), the opening and closing lock member 142a (FIG. 1), or the drive member 202a (FIG. 3) that is not connected to the first connecting member 21. For example, the right and left second connecting members 22 are respectively connected to the right and left opening and closing lock members 142a. That is, the second actuation member 32 is connected, via the second connecting member 22, to a lock mechanism (the second lock mechanism) different from the lock mechanism that operates in conjunction with the first actuation member 31, among the three types of lock mechanisms 141 to 143.

### Operation in First Position

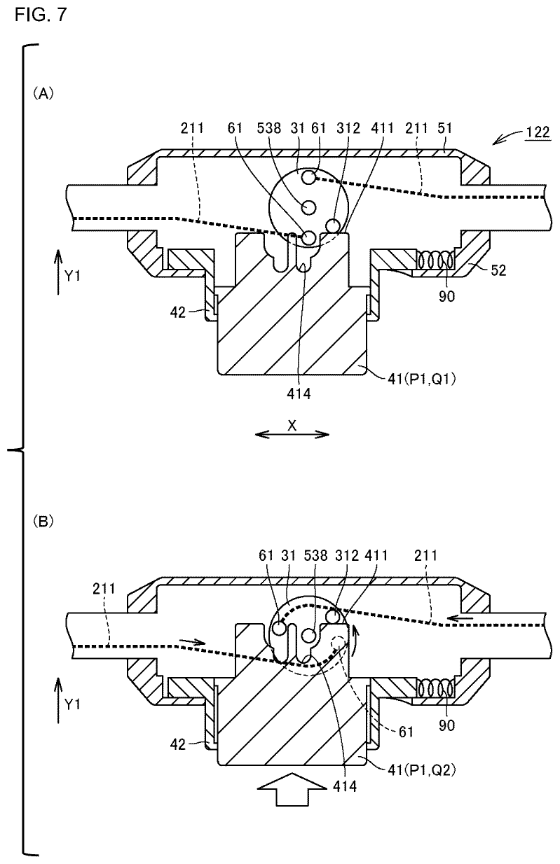

The operation of the operation member 4 will be described with reference to FIGS. 7 to 10 that schematically show the handle frame 122 as viewed from rear. FIGS. 7(A) and 7(B) show the relationship between the operation lever 41 and the first actuation member 31.

FIG. 7(A) shows a state in which the operation lever 41 is in a first position P1 in the left-right direction and a pre-operation position Q1 in the up-down direction. The guide portion 42 is biased toward the first position P1 by the elastic member 90. The first inner wires 211 are attached to the first actuation member 31 via the first fixtures 61. The first engaging portion 312 of the first actuation member 31 is positioned such that the first engaging portion 312 can contact the first contact portion 411 of the operation lever 41 (operation member) in the first position P1.

FIG. 7(B) shows a state in which the operation lever 41 has been pushed upward from the state in FIG. 7(A) and displaced from the pre-operation position Q1 to a post-operation position Q2. As the operation lever 41 in the first position P1 is displaced to the post-operation position Q2, the first actuation member 31 is actuated, and the first lock mechanism is unlocked via the first connecting member 21.

Specifically, as the operation lever 41 is displaced to the post-operation position Q2, the first engaging portion 312 in contact with the first contact portion 411 is pushed upward, and the first actuation member 31 is rotated counterclockwise in the figure about the rotation shaft 538. With this rotation, the first fixture 61 is also rotated, so that the first inner wire 211 connected to the first fixture 61 is wound up. As a result, the lock mechanism connected to the other end of the first inner wire 211 (any one of the push bar lock mechanism, the fold lock mechanism, or the caster lock mechanism) is unlocked.

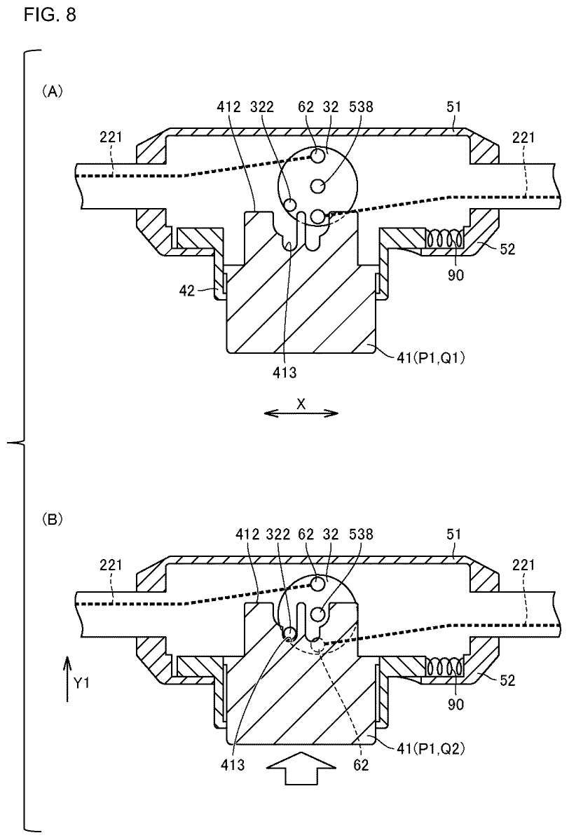

FIGS. 8(A) and 8(B) show the relationship between the operation lever 41 and the second actuation member 32. FIG. 8(A) shows a state in which the operation lever 41 is in the first position P1 and the pre-operation position Q1 as in FIG. 7(A). The second inner wires 221 are attached to the second actuation member 32 via the second fixtures 62. The second engaging portion 322 of the second actuation member 32 is positioned such that the second engaging portion 322 can be received by the first notch 413.

As shown in FIG. 8(B), when the operation lever 41 is pushed upward and displaced from the pre-operation position Q1 to the post-operation position Q2, the second contact portion 412 does not contact the second engaging portion 322. Instead, the second engaging portion 322 is received in the first notch 413. Therefore, the second actuation member 32 does not rotate. That is, the first notch 413 receives the second engaging portion 322 of the second actuation member 32 so as to avoid contact with the second engaging portion 322 when the first contact portion 411 of the operation lever 41 is in contact with the first engaging portion 312 of the first actuation member 31 in the post-operation position Q2 (FIG. 7(B)).

As the operation lever 41 in the first position P1 is displaced from the pre-operation position Q1 to the post-operation position Q2, the first contact portion 411 contacts the first engaging portion 312 and rotates the first actuation member 31, while the second actuation member 32 does not rotate because the first notch 413 receives the second engaging portion 322. Therefore, only the first actuation member 31 is actuated, and the first lock mechanism connected to the first actuation member 31 is activated.

When the upward pushing force acting on the operation lever 41 in the post-operation position Q2 is released, a restoring force from the lock mechanism acts on the first actuation member 31 via the first connecting member 21. As a result, the operation lever 41 in contact with the first actuation member 31 is pushed downward and returns to its original position (pre-operation position Q1). As shown in FIG. 6, a projecting portion 313 may be provided on the outer peripheral surface of the first actuation member 31 and a receiving portion 5311 configured to contact the projecting portion 313 may be provided on the base member 53 so that the actuation member is appropriately rotated back.

### Operation in Second Position

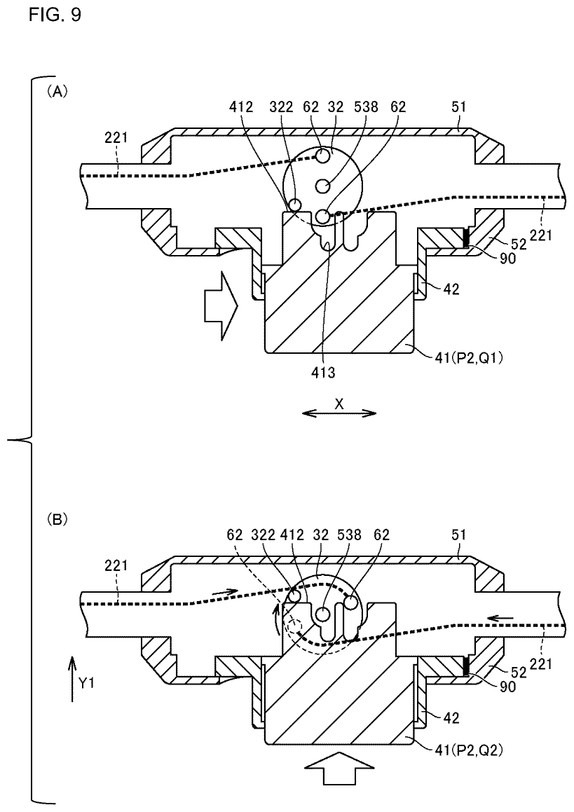

FIGS. 9(A) and (B) show the relationship between the operation lever 41 and the second actuation member 32. FIG. 9(A) shows a state in which the operation lever 41 is in a second position P2 and the pre-operation position Q1. That is, FIG. 9(A) shows a state in which the operation member (operation lever 41 and guide portion 42) in FIG. 8(A) has been displaced to one side in the left-right direction (second position P2) against the biasing force of the elastic member 90. In this state, the second engaging portion 322 of the second actuation member 32 is positioned such that the second engaging portion 322 can contact the second contact portion 412 of the operation lever 41 in the second position P2.

FIG. 9(B) shows a state in which the operation lever 41 has been pushed upward from the state in FIG. 9(A) and displaced from the pre-operation position Q1 to the post-operation position Q2. As the operation lever 41 in the second position P2 is displaced to the post-operation position Q2, the second actuation member 32 is actuated, and the second lock mechanism is unlocked via the second connecting member 22.

Specifically, as the operation lever 41 is displaced to the post-operation position Q2, the second engaging portion 322 in contact with the second contact portion 412 is pushed upward, and the second actuation member 32 is rotated clockwise in the figure about the rotation shaft 538. That is, the second actuation member 32 is displaced along a direction different from the displacement direction of the first actuation member 31. With this rotation, the second fixture 62 is also rotated, so that the second inner wire 221 connected to the second fixture 62 is wound up. As a result, the lock mechanism connected to the other end of the second inner wire 221 (any one of the push bar lock mechanism, the fold lock mechanism, or the caster lock mechanism that is not activated by the first connecting member 21) is unlocked.

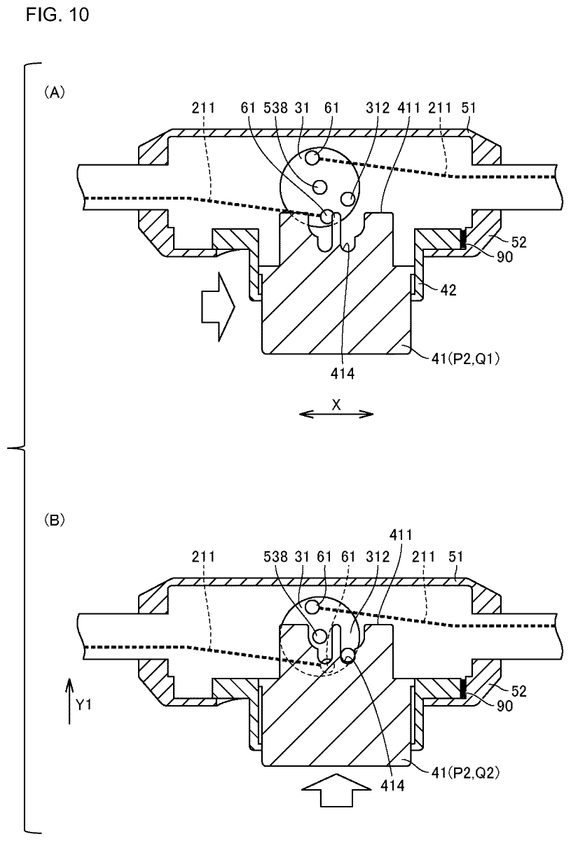

FIGS. 10(A) and 10(B) show the relationship between the operation lever 41 and the first actuation member 31. FIG. 10(A) shows a state in which the operation lever 41 is in the second position P2 and the pre-operation position Q1. That is, FIG. 10(A) shows a state in which the operation member (operation lever 41 and guide portion 42) in FIG. 7(A) has been displaced to one side in the left-right direction against the biasing force of the elastic member 90. As a result of this displacement, the first contact portion 411 is positioned away from the first engaging portion 312, while the second notch 414 is positioned such that it can receive the first engaging portion 312.

FIG. 10(B) shows a state in which the operation lever 41 has been pushed upward from the state in which the operation lever 41 is in the second position P2 (FIG. 10(A)) and displaced from the pre-operation position Q1 to the post-operation position Q2. When the operation lever 41 is displaced to the post-operation position Q2, the first contact portion 411 does not contact the first engaging portion 312. Instead, the first engaging portion 312 is received in the second notch 414. Therefore, the first actuation member 31 does not rotate.

That is, the second notch 414 receives the first engaging portion 312 of the first actuation member 31 so as to avoid contact with the first engaging portion 312 when the second contact portion 412 of the operation lever 41 is in contact with the second engaging portion 322 of the second actuation member 32 in the post-operation position Q2 (FIG. 9(B)).

When the upward pushing force acting on the operation lever 41 in the second position P2 and the post-operation position Q2 is released, a restoring force from the lock mechanism acts on the second actuation member 32 via the second connecting member 22. As a result, the operation lever 41 in contact with the second actuation member 32 is pushed downward and returns to the pre-operation position Q1. The operation lever 41 is also pushed toward one side in the left-right direction by the biasing force of the elastic member 90 and returns from the second position P2 to the first position P1.

In the present embodiment, to activate the first lock mechanism when the operation lever 41 is in the first position P1, the operation lever 41 is pushed upward to the post-operation position Q2 without being displaced in the left-right direction. On the other hand, to activate the second lock mechanism, the operation lever 41 is displaced to the second position P2 and then to the post-operation position Q2. As described above, since the first and second lock mechanisms are selectively operated by activating the operation member 4 (operation lever 41) at different positions (first position P1 and second position P2), it is easy for the operator to distinguish which lock mechanism to activate. Since the first and second actuation members 31, 32 can be selectively actuated by displacing one operation lever 41, the number of parts can be reduced.

Although any two of the three types of lock mechanisms can be designated as the first and second lock mechanisms, the second lock mechanism is preferably the fold lock mechanism. Since the second lock mechanism is activated by a two-step procedure, namely an operation of displacing the operation lever 41 from the first position P1 to the second position P2 and then to the post-operation position Q2, the risk of accidental and sudden folding of the stroller body can be reduced.

### Second Embodiment

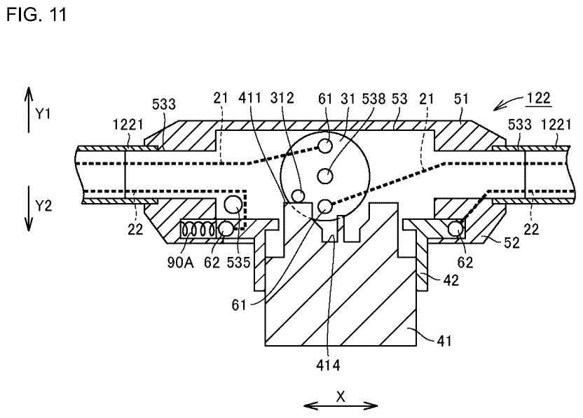

A second embodiment will be described with reference to FIGS. 11 to 13. FIG. 11 schematically shows the second embodiment.

### Overview of Handle Frame

The handle frame 122 includes a casing that forms part of the handle frame 122. The casing includes the upper cover member 51, the lower cover member 52, and the base member 53. Each of the fixing portions 533 on the right and left sides of the base member 53 is inserted into a corresponding one of the handle tubes 1221. The upper and lower cover members 51, 52 enclose the base member 53 and part of the handle tubes 1221.

### First Actuation Member

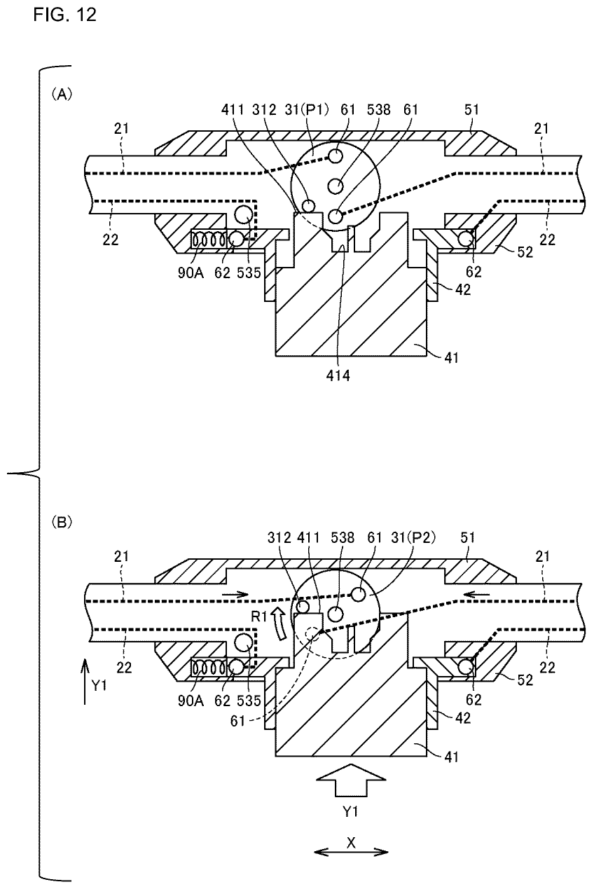

In the present embodiment, the rotating body 31 is the first actuation member. The rotating body 31 is housed in the base member 53 (casing) and is rotatably supported by the base member 53 via the rotation shaft 538. That is, the rotating body 31 is rotatable in a rotational direction R1 (FIG. 12(B)) around the rotation shaft 538.

The rotating body 31 is connected to the first lock mechanism via the first connecting member 21. The first connecting member 21 having its one end connected to the rotating body 31 is connected, at its other end, to one of the handle lock member 141a (FIG. 1), the opening and closing lock member 142a (FIG. 1), or the drive member 202a (FIG. 3). For example, the right and left first connecting members 21 are respectively connected the right and left handle lock members 141a. That is, the first actuation member 31 is connected, via the first connecting member 21, to one (the first lock mechanism) of the three types of lock mechanisms 141 to 143 described above.

Specifically, the first fixture 61 is fixed to the outer periphery of the rotating body 31, and the first connecting member 21 having its one end connected to the first fixture 61 passes through the handle tube 1221 and is connected, at its other end, to the first lock mechanism. The rotating body 31 includes the engaging portion 312 at its outer periphery. The engaging portion 312 is configured to contact the operation lever 41 (operation member). As will be described later, the rotating body 31 is displaceable (rotatable) between a first pre-actuation position and a first post-actuation position along the rotational direction.

### Second Actuation Member

In the present embodiment, the guide portion 42 is the second actuation member. The guide portion 42 is housed in the lower cover member 52 (casing) and is slidable linearly in the left-right direction (left-right direction X).

The guide portion 42 is connected to the second lock mechanism via the second connecting member 22. The second connecting member 22 having its one end connected to the guide portion 42 is connected, at its other end, to any one of the handle lock member 141a (FIG. 1), the opening and closing lock member 142a (FIG. 1), or the drive member 202a (FIG. 3) that is not connected to the first connecting member 21. For example, the right and left second connecting members 22 are respectively connected to the right and left opening and closing lock members 142a. That is, the second actuation member 32 is connected, via the second connecting member 22, to a lock mechanism (the second lock mechanism) different from the lock mechanism that operates in conjunction with the first connecting member 21, among the three types of lock mechanisms 141 to 143.

Specifically, the second fixtures 62 are fixed to the right and left sides of the guide portion 42. The second connecting member 22 having its one end connected to the second fixture 62 passes through the handle tube 1221 and is connected, at its other end, to the second lock mechanism. The guide portion 42 is biased toward one side in the left-right direction by an elastic member 90A (e.g., a spring or rubber) disposed between the guide portion 42 and the lower cover member 52. In the present embodiment, the elastic member 90A is housed in the casing (lower cover member 52). However, the present invention is not limited to this, and the elastic member may be provided in the lock mechanism to bias the guide portion 42 toward one side in the left-right direction. As will be described later, the guide portion 42 is displaceable between a second pre-actuation position and a second post-actuation position along the left-right direction. One of the second connecting members 22 (left in the figure) is hooked onto a hooking portion 535.

### Operation Member

As will be described below, in the present embodiment, the operation member (operation lever 41) activates one of the first and second lock mechanisms when operated in one direction, and activates the other of the first and second lock mechanisms when operated in the other direction. The operation lever 41 is held by the guide portion 42 such that the operation lever 41 is slidable in the left-right direction together with the guide portion 42 and is slidable in a direction intersecting the left-right direction, namely in the up-down direction. The operation lever 41 includes the contact portion 411 on one side in the left-right direction, and the notch 414 is located adjacent to the contact portion 411. The contact portion 411 is configured to contact the engaging portion 312 of the rotating body 31. As will be described later, the operation lever 41 selectively actuates one of the rotating body 31 and the guide portion 42.

### Operation of First Actuation Member

The operation of the rotating body 31 will be described with reference to FIG. 12. The rotating body 31 is in a first pre-actuation position P1 in FIG. 12(A) and in a first post-actuation position P2 in FIG. 12(B).

In FIG. 12(A), the rotating body 31 has the engaging portion 312 configured to contact the operation lever 41. That is, the engaging portion 312 is in contact with or close to the contact portion 411 of the operation lever 41. As shown in FIG. 12B, the operation lever 41 is operated in the upward direction Y1 (first direction) from this state. As a result, the rotating body 31 is moved from the first pre-actuation position P1 to the first post-actuation position P2. The first lock mechanism is thus unlocked via the first connecting member 21.

Specifically, as the rotating body 31 is displaced to the first post-actuation position P2, the engaging portion 312 in contact with the contact portion 411 is pushed upward, and the rotating body 31 is rotated clockwise in the figure around the rotation shaft 538. With this rotation, the first fixture 61 is also rotated, so that the first connecting member 21 connected to the first fixture 61 is wound up. As a result, the lock mechanism connected to the other end of the first connecting member 21 (any one of the push bar lock mechanism, the fold lock mechanism, or the caster lock mechanism) is unlocked.

When the upward pushing force acting on the operation lever 41 in the post-actuation position Q2 is released, a restoring force from the lock mechanism acts on the rotating body 31 via the first connecting member 21. As a result, the operation lever 41 in contact with the engaging portion 312 is pushed downward and returns to its original position (pre-actuation position Q1).

### Operation of Second Actuation Member

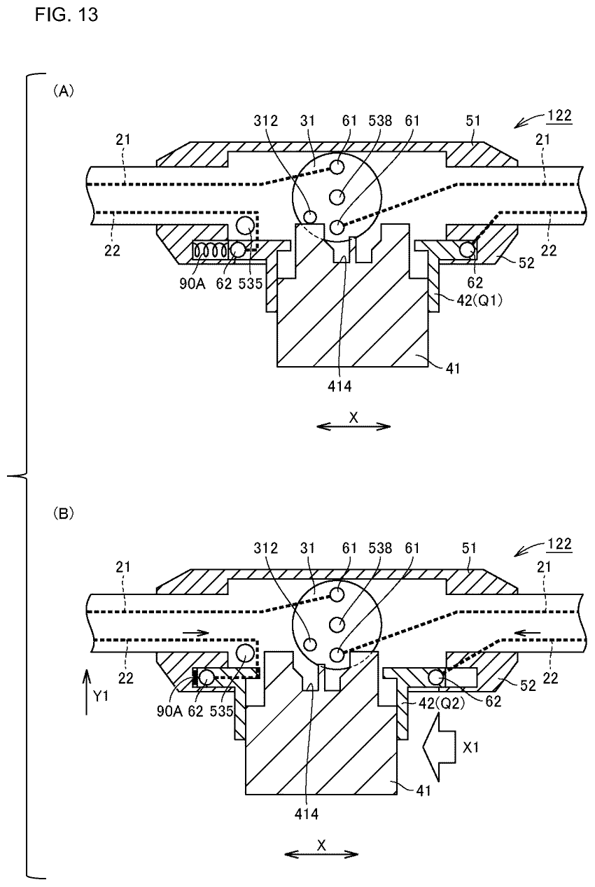

The operation of the guide portion 42 will be described with reference to FIG. 13. The guide portion 42 is in a second pre-actuation position Q1 in FIG. 13(A) and in a second post-actuation position Q2 in FIG. 13(B). As shown in FIG. 13(A), the guide portion 42 is biased toward the second pre-actuation position Q1 by the elastic member 90A disposed in the lower cover member 52 (casing).

As shown in FIG. 13(B), when the guide portion 42 is moved from the second pre-actuation position Q1 to the second post-actuation position Q2 through the operation of the operation lever 41 in the left-right direction X1 (second direction), the second lock mechanism is unlocked via the second connecting member 22.

Specifically, as the guide portion 42 is displaced to the second post-actuation position Q2, one (right in the figure) of the second connecting members 22 each fixed to the guide portion 42 via the corresponding second fixture 62 is pulled by the guide portion 42. The other second connecting member 22 (left in the figure) is hooked onto the hooking portion 535 and is therefore drawn in the opposite direction to the displacement direction of the guide portion 42. These pulling and drawing actions unlock the lock mechanism connected to the other end of the second connecting member 22 (any one of the push bar lock mechanism, the fold lock mechanism, or the caster lock mechanism that is not connected to the first connecting member 21).

When the external force acting on the guide portion 42 in the second post-actuation position Q2 is released, the biasing force of the elastic member 90A acts on the guide portion 42, and the guide portion 42 returns to its original position (the second pre-actuation position Q1).

The operation lever 41 may have the notch 414 for avoiding contact between the rotation shaft 538 and the operation lever 41.

In the present embodiment, to activate the first lock mechanism, the operation lever 41 is pushed upward (first direction Y1) and the rotating body 31 is displaced from the first pre-actuation position P1 to the first post-actuation position P2 in the rotational direction. On the other hand, to activate the second lock mechanism, the operation lever 41 is slid to the right or left (second direction X1) and displaced together with the guide portion 42 from the second pre-actuation position Q1 to the second post-actuation position Q2 in the left-right direction. As described above, since the first and second lock mechanisms can be selectively activated by changing the direction in which the operation member (operation lever 41) is operated, it is easy for the operator to distinguish which lock mechanism to activate.

### Third Embodiment

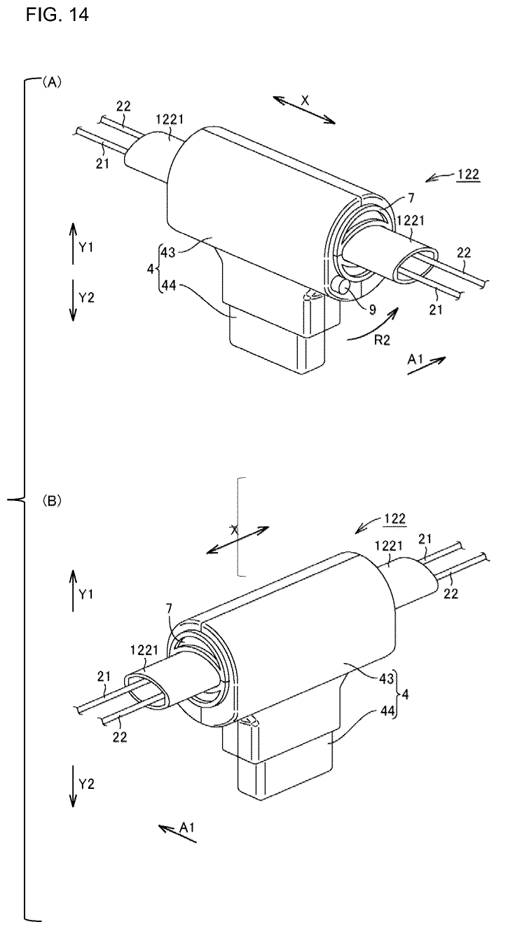

A third embodiment will be described with reference to FIGS. 14 to 19. FIGS. 14(A) and 14(B) schematically show the handle frame 122 of the present embodiment.

### Overview of Handle Frame

A guide member 7 is attached to the outer peripheral surface of the handle tube 1221 of the handle frame 122, and the operation member 4 is attached to the guide member 7. In the present embodiment, the operation member 4 includes a rotation operation portion 43 and a linear operation portion 44. As will be described below, one of the first and second lock mechanisms is activated by operating the rotation operation portion 43 in one direction, and the other of the first and second lock mechanisms is activated by operating the linear operation portion 44 in the other direction. The structure of the handle frame 122 will be described below with reference to FIGS. 14 to 16.

### Handle Tube

In the present embodiment, the handle tube 1221 extends continuously in the left-right direction. A through hole 1222 is formed on one side of the middle part of the handle tube 1221. As will be described later, the connecting members extend through the through hole 1222 so as to extend both inside and outside of the handle tube 1221.

### Guide Member

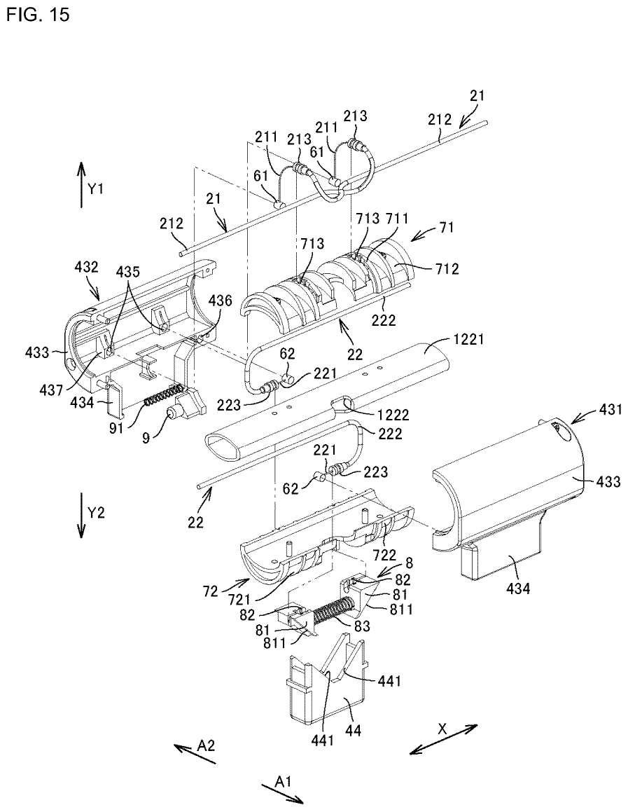

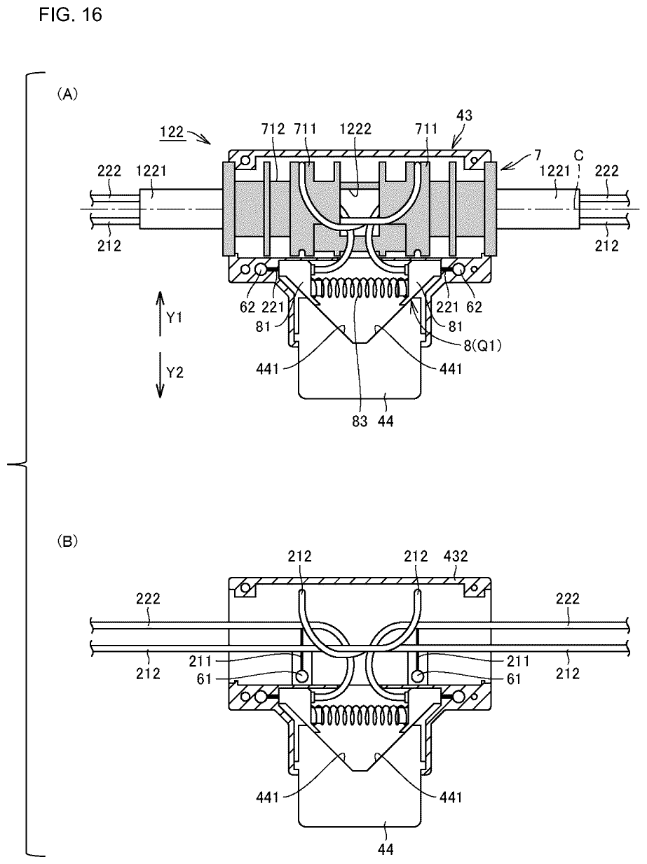

As shown in FIG. 16(A), the guide member 7 extends along the central axis C of the handle frame 122 and is fixed to the handle tube 1221. As shown in FIG. 15, the guide member 7 includes an upper guide member 71 and a lower guide member 72, and is attached so as to sandwich the handle tube 1221 from above and below. The upper and lower guide members 71, 72 each have the shape of a bellows with multiple ridges 711, 721 and multiple recesses 712, 722 repeating in the left-right direction. Amounting groove 713 is formed in two ridges 711 of the upper guide member 71.

### Rotation Operation Portion

The rotation operation portion 43 includes a front rotation operation portion 431 and a rear rotation operation portion 432. The rotation operation portion 43 sandwiches the handle tube 1221 and the guide member 7 from front and rear. The rotation operation portion 43 is rotatable around the guide member 7, with the central axis of the guide member 7 acting as the axis of rotation. That is, the rotation operation portion 43 is operable along a rotational direction R2 (first direction) shown in FIG. 14(A).

The rotation operation portion 43 includes a first housing portion 433 that houses the handle tube 1221 and the guide member 7, and a second housing portion 434 that houses the linear operation portion 44. The first housing portion 433 of the rear rotation operation portion 432 has a pair of first fixing holes 435. The rear rotation operation portion 432 has a second fixing hole 436 on one side in the left-right direction. Although not shown in the figures, the front rotation operation portion 431 has a second fixing hole 436 on the other side in the left-right direction.

A rotation stopper member 9 that prohibits and permits rotation of the rotation operation portion 43 is provided on one side of the rear rotation operation portion 432 in the left-right direction. The rotation stopper member 9 is biased in one direction by a spring 91 interposed between the rotation stopper member 9 and a support portion 437 of the rear rotation operation portion 432. The rotation stopper member 9 will be described later.

### Expandable Actuation Member

An expandable actuation member 8 is disposed between the guide member 7 (lower guide member 72) and the linear operation portion 44 in the up-down direction such that the expandable actuation member 8 can contact the linear operation portion 44. The expandable actuation member 8 includes a pair of actuation pieces 81 spaced apart from each other in the left-right direction, and an expandable portion 83 interposed between the opposing surfaces of the actuation pieces 81. The actuation pieces 81 are actuated to move toward or away from each other. A mounting groove 82 is formed in the upper surface of each actuation piece 81 along the left-right direction. Each actuation piece 81 has an inclined portion 811 extending obliquely and intersecting the upper surface of the actuation piece 81.

### Linear Operation Portion

As shown in FIG. 16(A), the linear operation portion 44 is operable along the upward direction Y1 (second direction). Specifically, the linear operation portion 44 is held by the rotation operation portion 43 so as to be slidable in the up-down direction. The linear operation portion 44 is provided below the expandable actuation member 8 and actuates the expandable actuation member 8. That is, the expandable actuation member 8 is disposed between the guide member 7 and the linear operation portion 44 such that the expandable actuation member 8 can contact the linear operation portion 44. The linear operation portion 44 includes, on the upper side, a receiving portion 441 that receives the actuation piece 81 of the expandable actuation member 8. The receiving portion 441 is provided on the right and left sides of the linear operation portion 44. The receiving portions 441 together form a generally V-shape such that the distance between them increases as they extend upward.

### Connecting Members

The connecting members includes the first connecting members 21 and the second connecting members 22. Each first connecting member 21 includes the first inner wire 211 and the first outer cover 212 that slidably encloses the first inner wire 211. Each first connecting member 21 passes through the through hole 1222 from within the handle tube 1221, and the end 213 of the first outer cover 212 is fitted into a corresponding one of the mounting grooves 713 in the ridges 711 of the upper guide member 71. The first fixture 61 is attached to one end of each first inner wire 211. Each first fixture 61 is fitted into a corresponding one of the first fixing holes 435 of the rear rotation operation portion 432, as shown by dashed double-short dashed lines in FIG. 15.

Each second connecting member 22 includes the second inner wire 221 and the second outer cover 222 that slidably encloses the second inner wire 221. Each second connecting member 22 passes through the through hole 1222 from within the handle tube 1221, and an end 223 of the second outer cover 222 is fitted into a corresponding one of the mounting grooves 82 formed in the actuation pieces 81 of the expandable actuation member 8. The second fixture 62 is attached to one end of each second inner wire 221. Each second fixture 62 is fitted into a corresponding one of the second fixing holes 436 of the front and rear rotation operation portions 431, 432, as shown by dashed double-short dashed lines in FIG. 15.

### First Actuation Member

In the present embodiment, the first fixture 61 attached to the first inner wire 211 is the first actuation member and is actuated by the rotation operation portion 43. The first connecting member 21 having its one end connected to the first fixture 61 is connected, at its other end, to one of the handle lock member 141a (FIG. 1), the opening and closing lock member 142a (FIG. 1), or the drive member 202a (FIG. 3). For example, the right and left first connecting members 21 are respectively connected the right and left handle lock members 141a. That is, the first fixture 61 is connected, via the first connecting member 21, to one (the first lock mechanism) of the three types of lock mechanisms 141 to 143 described above.

Specifically, the first fixture 61 is displaceable between a first pre-actuation position and a first post-actuation position along the direction of rotation (first direction) around the central axis of the guide member 7. That is, as shown in FIGS. 15 and 16(B), since the first fixture 61 is fixed to the first fixing hole 435 of the rear rotation operation portion 432, the first fixture 61 is rotated when an operation of rotating the rotation operation portion 43 is performed. As a result, the lock mechanism at the other end of the first connecting member 21 is activated via the first inner wire 211.

### Second Actuation Member

In the present embodiment, the expandable actuation member 8 is the second actuation member. The second connecting member 22 having its one end connected to the expandable actuation member 8 is connected, at its other end, to any one of the handle lock member 141a (FIG. 1), the opening and closing lock member 142a (FIG. 1), or the drive member 202a (FIG. 3) that is not connected to the first connecting member 21. For example, the right and left second connecting members 22 are respectively connected to the right and left opening and closing lock members 142a. That is, the expandable actuation member 8 is connected, via the second connecting member 22, to a lock mechanism (the second lock mechanism) different from the lock mechanism that operates in conjunction with the first actuation member, among the three types of lock mechanisms 141 to 143.

Specifically, the expandable actuation member 8 is displaceable between a second pre-actuation position and a second post-actuation position along the left-right direction (second direction) different from the first direction. In other words, when the linear operation portion 44 provided below the expandable actuation member 8 is pushed upward, the receiving portions 441 of the linear operation portion 44 slide against the actuation pieces 81, linearly displacing the actuation pieces 81 toward each other in the left-right direction.

### Operation of First Actuation Member

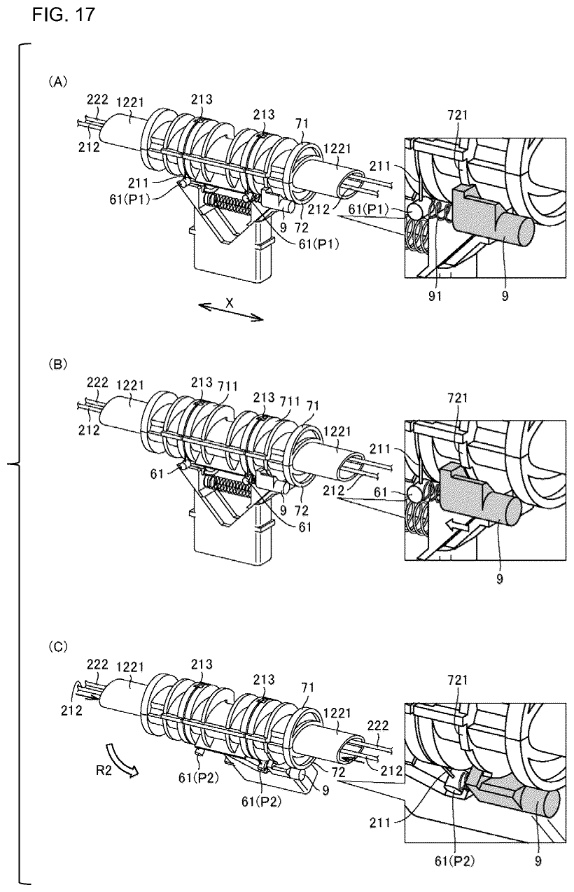

The operation of the first fixture (first actuation member) 61 will be described with reference to FIGS. 17(A) to 17(C). The first fixture 61 is in the first pre-actuation position P1 in FIG. 17(A) and in the first post-actuation position P2 in FIG. 17(C). The rotation operation portion 43 is not shown in FIGS. 17(A) to 17(C).

In the first pre-actuation position P1 in FIG. 17(A), as shown in the enlarged view in FIG. 17(A), the ridge 721 of the lower guide member 72 and the rotation stopper member 9 are in contact with each other in the circumferential direction. In other words, the rotation stopper member 9 is in an engaged state in which the rotation of the rotation operation portion 43 is prohibited.

As shown in FIG. 17(B), when the rotation stopper member 9 is pushed in the direction of the arrow, the rotation stopper member 9 is disengaged from the ridge 721. Namely, the rotation stopper member 9 is switched to a disengaged state in which the rotation of the rotation operation portion 43 is permitted. As shown in FIG. 17(C), when the rotation operation portion 43 is operated in the rotational direction (first direction R2) in the disengaged state, the rotation operation portion 43 is rotated around the guide member 7 fixed to the handle tube 1221. As a result, the first fixture 61 fixed to the rotation operation portion 43 is also rotated and displaced to the first post-actuation position P2. During the rotation of the rotation operation portion 43, the rotation stopper member 9 is rotated while sliding against the side surface of the ridge 721.

The first fixture 61 is rotated such that the first inner wire 211 is pulled out from the end 213 of the first outer cover 212 fixed to the ridge 711 of the upper guide member 71. The lock mechanism connected to the other end of the first inner wire 211 (any one of the push bar lock mechanism, the fold lock mechanism, or the caster lock mechanism) is activated.

As described above, as the first fixture 61 is actuated from the first pre-actuation position P1 to the first post-actuation position P2 by the rotation operation portion (operation member) 43, the first lock mechanism is unlocked via the first inner wire (first connecting member) 211.

When the force that rotates the rotation operation portion 43 in the first post-actuation position P2 is released, a restoring force from the lock mechanism acts on the first fixture 61 via the first inner wire 211. As a result, the first fixture 61 together with the rotation operation portion 43 returns to the first pre-actuation position P1.

### Operation of Second Actuation Member

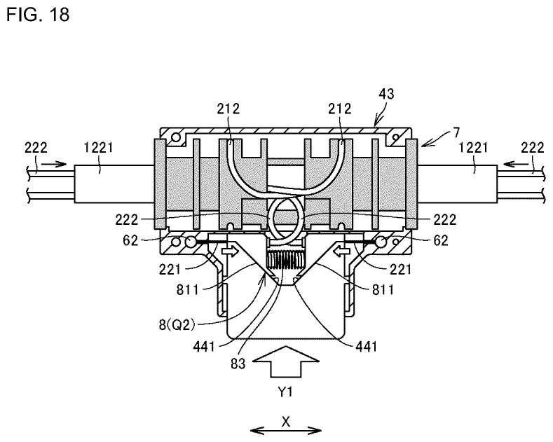

The operation of the expandable actuation member 8 (second actuation member) will be described with reference to FIGS. 16(A), 18, and 19. The expandable actuation member 8 is in the second pre-actuation position Q1 in FIG. 16(A) and in the second post-actuation position Q2 in FIG. 18. In the second pre-actuation position Q1, the right and left actuation pieces 81 are biased away from each other in the left-right direction by the expandable portion 83.

The expandable actuation member 8 is disposed such that it can contact the linear operation portion 44. As shown in FIG. 18, when the linear operation portion 44 is operated upward (second direction Y1) (displaced toward the guide member 7), the expandable actuation member 8 is displaced from the second pre-actuation position Q1 to the second post-actuation position Q2. As a result, the second lock mechanism is unlocked via the expandable actuation member 8.

Specifically, when the linear operation portion 44 housed in the rotation operation portion 43 is pushed upward, the receiving portions 441 of the linear operation portion 44 slides against the inclined portions 811 of the actuation pieces 81. As shown in FIG. 18, the actuation pieces 81 are thus displaced toward each other and reach the second post-actuation position Q2. Since the end 223 of each second outer cover 222 is fixed to a corresponding one of the actuation pieces 81 (FIG. 15), each second outer cover 222 is loosened with the displacement of the actuation pieces 81. As a result, the second inner wire 221 on the second lock mechanism side is pulled up. This pulling action unlocks the lock mechanism connected to the other end of the second inner wire 221 (any one of the push bar lock mechanism, the fold lock mechanism, or the caster lock mechanism that is not connected to the first fixture 61).

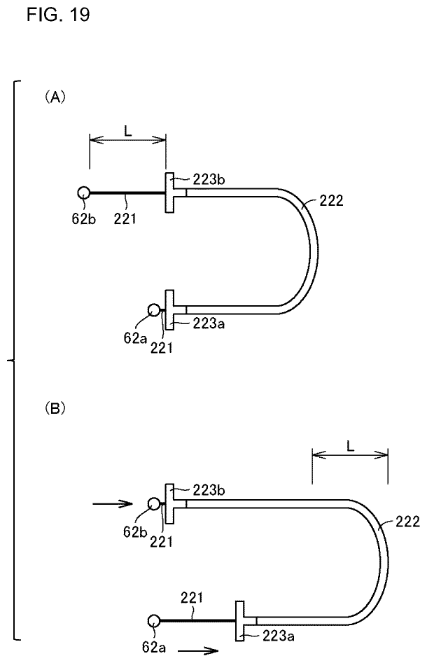

The behavior of the second inner wire 221 will be briefly described with reference to FIG. 19. In FIGS. 19(A) and 19(B), the end of the second outer cover 222 on the actuation piece 81 side is shown by reference sign 223a, and the end of the second outer cover 222 on the lock mechanism side is shown by reference sign 223b. The end 223b on the lock mechanism side is fixed and will not be displaced. The end of the second inner wire 221 that is fixed to the rotation operation portion 43 is shown by reference sign 62a, and the end of the second inner wire 221 on the lock mechanism side is shown by reference sign 62b. The end 62a on the rotating operation portion side is fixed and will not be displaced in the left-right direction.

As shown in FIG. 19(B), when the end 223a of the second outer cover 222 on the actuation piece 81 side is displaced in one direction by a distance L, the second inner wire 221 passing through the second outer cover 222 is displaced in the same direction together with the second outer cover 222. Therefore, the end 62b of the second inner wire 221 on the lock mechanism side is pulled up by the distance L.

When the external force applied to the linear operation portion 44 in the second post-actuation position Q2 is released, the actuation pieces 81 are displaced in the left-right direction by the biasing force of the expandable actuation member 8 so as to push down the linear operation portion 44. As a result, the linear operation portion 44 returns to its original position (second pre-actuation position Q1).

According to the present embodiment, to activate the first lock mechanism, the rotation operation portion 43 is rotated around the guide member 7 to rotate and displace the first fixture 61 fixed to the rotation operation portion 43 from the first pre-actuation position P1 to the first post-actuation position P2. On the other hand, to activate the second lock mechanism, the linear operation portion 44 is pushed upward to displace the actuation pieces 81 of the expandable actuation member 8 from the second pre-actuation position Q1 to the second post-actuation position Q2. As described above, since the operation member is moved in different directions (rotational direction and linear direction) to actuate different operation members, it is easy for the operator to distinguish which lock mechanism to activate.

### Others

The above embodiments each illustrate the first and second lock mechanisms that can be switched from a locked state to an unlocked state by the operation member. However, the present invention is not limited to this, and a lock mechanism that can be switched from an unlocked state to a locked state may be adopted. For example, as one type of lock mechanism, a lock mechanism that can be switched from a brake disengaged state to a brake engaged state through the operation of the operation member may be used for a stroller brake.

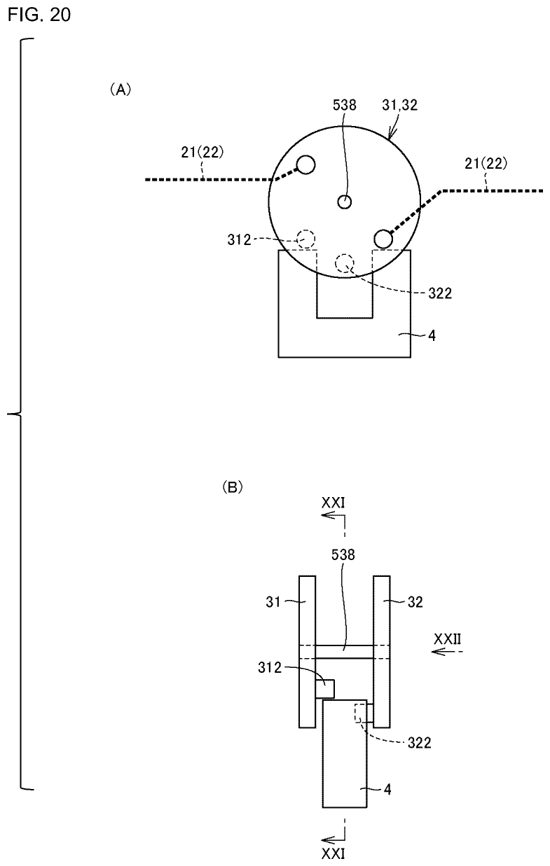

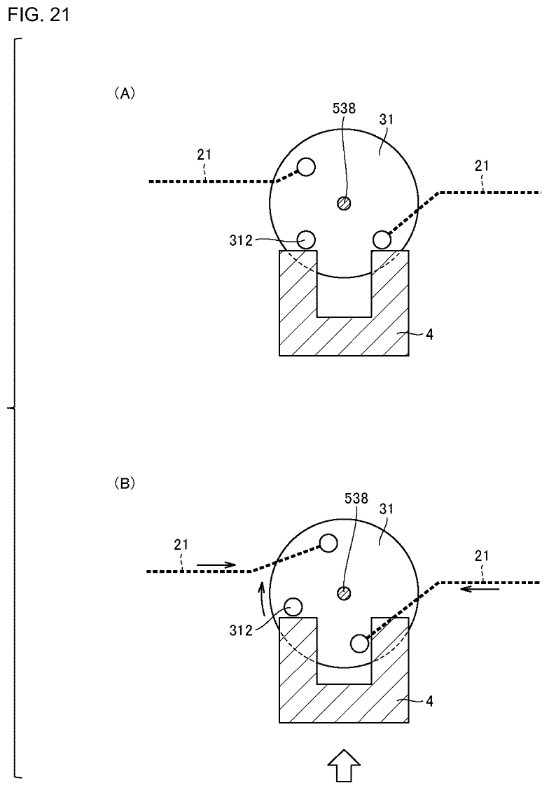

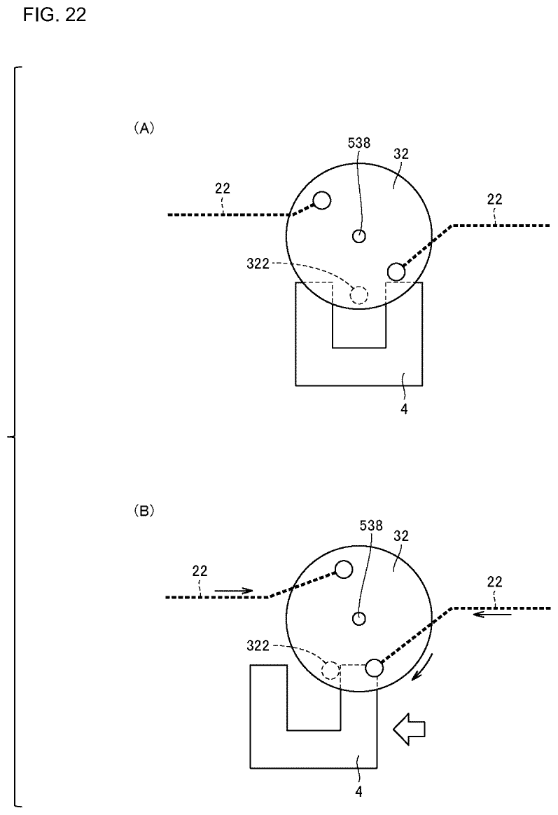

The above embodiments each illustrate an example in which the first and second actuation members are actuated in different directions. However, as shown in FIGS. 20 to 22, the first and second actuation members may be actuated in the same direction. Specifically, as shown in FIG. 21, the first actuation member 31 may be actuated in a rotational direction (clockwise direction) when the operation member 4 is operated in one direction (upward in the figure), and as shown in FIG. 22, the second actuation member 32 may be actuated in the same rotational direction (clockwise direction) when the operation member 4 is operated in a different direction (leftward in the figure).

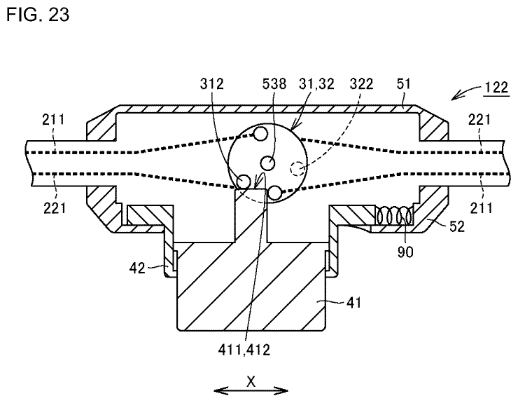

In the first embodiment, the operation lever 41 has the first and second notches 413, 414. However, the first and second notches 413, 414 may not be provided. That is, as shown in FIG. 23, the first and second contact portions 411, 412 may be located at the same position in the left-right direction X, and the first contact portion 411 may contact the first engaging portion 312 and the second contact portion 412 may contact the second engaging portion 322.

A single connecting member may be fixed to the actuation member instead of a pair of connecting members.

In the second embodiment, the guide portion 42 holds the operation lever 41 and is displaced in the left-right direction together with the operation lever 41. However, two independent operation members may be provided. Namely, a member that is displaced only in the left-right direction and a member that is displaced only in the up-down direction may be provided.

While the embodiments of the present invention have been described above with reference to the drawings, the present invention is not limited to the illustrated embodiments. Various changes and modifications may be made to the illustrated embodiments without departing from the spirit and scope of the invention.

1. A stroller comprising:
a body frame including a wheel;
a handle frame configured to perform an operation of moving the body frame;
a first lock mechanism configured to switch one movable portion out of a plurality of movable portions of the body frame between a locked state and an unlocked state;
a second lock mechanism configured to switch another movable portion of the body frame between a locked state and an unlocked state, the another movable portion being located at a different position from the one movable portion; and
an operation member provided in the handle frame and configured to selectively actuate one of the first and second lock mechanisms, wherein
the operation member is configured to be operated in a first direction and a second direction different from the first direction,
the first lock mechanism is switched to a locked state or an unlocked state by operating the operation member in the first direction, and
the second lock mechanism is switched to a locked state or an unlocked state by operating the operation member in the second direction.

2. The stroller according to claim 1, wherein
the first direction and the second direction intersect each other.

3. The stroller according to claim 1, further comprising:
a first actuation member provided in the handle frame and connected to the first lock mechanism via a first connecting member; and
a second actuation member provided in the handle frame and connected to the second lock mechanism via a second connecting member, wherein
the first actuation member is actuated by operating the operation member in the first direction, and
the second actuation member is actuated by operating the operation member in the second direction.

4. The stroller according to claim 3, wherein
the first actuation member is displaceable between a first pre-actuation position and a first post-actuation position by operating the operation member in the first direction;
the second actuation member is displaceable between a second pre-actuation position and a second post-actuation position by operating the operation member in the second direction;
the first lock mechanism is switched to the locked state or the unlocked state via the first connecting member as the first actuation member is moved from the first pre-actuation position to the first post-actuation position through operation of the operation member; and
the second lock mechanism is switched to the locked state or the unlocked state via the second connecting member as the second actuation member is moved from the second pre-actuation position to the second post-actuation position through operation of the operation member.

5. The stroller according to claim 4, wherein
a direction in which the first actuation member is moved from the first pre-actuation position to the first post-actuation position is a rotational direction, and
a direction in which the second actuation member is moved from the second pre-actuation position to the second post-actuation position is a linear direction.

6. The stroller according to claim 5, wherein
the handle frame includes a casing that houses the first and second actuation members, the casing forming part of the handle frame,
the first actuation member is a rotating body that is rotatably supported by the casing via a shaft, the rotating body being rotatable in the rotational direction,
the second actuation member holds the operation member such that the operation member is slidable in a direction intersecting the linear direction, and
the first actuation member includes an engaging portion configured to contact the operation member in the second pre-actuation position.

7. The stroller according to claim 6, further comprising:
an elastic member configured to bias the second actuation member toward the second pre-actuation position.

8. The stroller according to claim 5, wherein
the handle frame includes a guide member extending along a central axis of the handle frame and fixed to the handle frame,
the operation member includes
a rotation operation portion that houses the guide member, the first actuation member, and the second actuation member, the rotation operation portion being configured to actuate the first actuation member, and
a linear operation portion configured to actuate the second actuation member,
the rotation operation portion is rotatable around a central axis of the guide member, and
the first actuation member is fixed to the rotation operation portion.

9. The stroller according to claim 8, wherein
the rotation operation portion holds the linear operation portion such that the linear operation portion is slidable in a direction intersecting the linear direction.

10. The stroller according to claim 9, wherein
the second actuation member is disposed between the guide member and the linear operation portion such that the second actuation member is allowed to contact the linear operation portion, and
the second actuation member is displaced from the second pre-actuation position to the second post-actuation position as the linear operation portion is moved toward the guide member.

11. The stroller according to claim 9, further comprising:
a rotation stopper member configured to switch between an engaged state in which rotation of the rotation operation portion is prohibited and a disengaged state in which the rotation of the rotation operation portion is permitted.

12. A stroller, comprising:
a body frame including a wheel;
a handle frame configured to perform an operation of moving the body frame;
a first lock mechanism configured to switch one movable portion out of a plurality of movable portions of the body frame between a locked state and an unlocked state;
a second lock mechanism configured to switch another movable portion of the body frame between a locked state and an unlocked state, the another movable portion being located at a different position from the one movable portion;
a first actuation member provided in the handle frame and connected to the first lock mechanism via a first connecting member, the first actuation member being displaceable between a first pre-actuation position and a first post-actuation position along one direction;
a second actuation member provided in the handle frame and connected to the second lock mechanism via a second connecting member, the second actuation member being displaceable between a second pre-actuation position and a second post-actuation position along another direction different from the one direction; and
an operation member provided in the handle frame and configured to selectively actuate one of the first and second actuation mechanisms, wherein
the first lock mechanism is released from the locked state via the first connecting member as the first actuation member is moved from the first pre-actuation position to the first post-actuation position by the operation member, and
the second lock mechanism is released from the locked state via the second connecting member as the second actuation member is moved from the second pre-actuation position to the second post-actuation position by the operation member.
